(19) United States
(12) Patent Application Publication
(10) Pub. No.: US 2026/0267894 A1
(43) Pub. Date: Sep. 10, 2026

(54) CONTENT RECOMMENDATION BASED ON EMBEDDING SUMMARIZATION

(71) Applicant: Microsoft Technology Licensing, LLC, Redmond, WA (US)

(72) Inventors: Shaoguang YAN, Beijing (CN); Yunqing Xia, Beijing (CN); Dong Wang, Beijing (CN); Weiwei DENG, Beijing (CN); Qi ZHANG, Suzhou (CN)

(21) Appl. No.: 18/876,837

(22) PCT Filed: Jul. 14, 2023
(86) PCT No.: PCT/US2023/027718

§ 371 Date: Dec. 19, 2024

(30) Foreign Application Priority Data
Aug. 2, 2022 (CN) 202210921856.7

(51) Int. Cl. G06F 16/335; G06F 16/34

(52) U.S. Cl. CPC G06F 16/335; G06F 16/345

(57) ABSTRACT

The present disclosure proposes content recommendation based on embedding summarization. A text input may be obtained, the text input including a basic input and a context input, the basic input including a candidate content item. An embedding sequence corresponding to the basic input and an embedding sequence corresponding to the context input may be generated. A pooling embedding may be generated through performing a pooling operation on the embedding sequence corresponding to the basic input. A representative embedding sequence corresponding to the context input may be obtained through performing a summary operation on the embedding sequence corresponding to the context input. A text input representation of the text input may be generated based on the embedding sequence corresponding to the basic input and the representative embedding sequence. A click probability of the candidate content item being clicked may be predicted based on the text input representation.

### BACKGROUND

With the development of network technology and the growth of network information, recommendation systems are playing an increasingly important role in many online services. Based on different recommended content, there are different recommendation systems, e.g., news recommendation system, video recommendation system, book recommendation system, product recommendation system, etc. These recommendation systems may usually perform personalized recommendations for target users. Herein, a target user refers to the user for whom content recommendation is performed. For example, a recommendation system usually captures user interests of a target user, and predict content that the user is interested in based on the user interests and recommend the content to the user.

### SUMMARY

This Summary is provided to introduce a selection of concepts that are further described below in the Detailed Description. It is not intended to identify key features or essential features of the claimed subject matter, nor is it intended to be used to limit the scope of the claimed subject matter.

Embodiments of the present disclosure propose a method, apparatus and computer program product for content recommendation based on embedding summarization. A text input may be obtained, the text input including a basic input and a context input corresponding to the basic input, the basic input including at least a candidate content item. An embedding sequence corresponding to the basic input and an embedding sequence corresponding to the context input may be generated. A pooling embedding corresponding to the basic input may be generated through performing a pooling operation on the embedding sequence corresponding to the basic input. A representative embedding sequence corresponding to the context input may be obtained through performing a summary operation on the embedding sequence corresponding to the context input with the pooling embedding. A text input representation of the text input may be generated based at least on the embedding sequence corresponding to the basic input and the representative embedding sequence corresponding to the context input. A click probability of the candidate content item being clicked may be predicted based on the text input representation. It should be noted that the above one or more aspects comprise the features hereinafter fully described and particularly pointed out in the claims. The following description and the drawings set forth in detail certain illustrative features of the one or more aspects. These features are only indicative of the various ways in which the principles of various aspects may be employed, and this disclosure is intended to include all such aspects and their equivalents.

### BRIEF DESCRIPTION OF THE DRAWINGS

The disclosed aspects will hereinafter be described in connection with the appended drawings that are provided to illustrate and not to limit the disclosed aspects.

FIG. 1 illustrates an exemplary process for content recommendation based on embedding summarization according to an embodiment of the present disclosure.

FIG. 2 illustrates an exemplary process for performing a summary operation on an embedding sequence corresponding to a context input according to an embodiment of the present disclosure.

FIG. 3 illustrates an exemplary process for predicting a click probability of a candidate content item being clicked through a click probability predicting model according to an embodiment of the present disclosure.

FIG. 4 illustrates another exemplary process for predicting a click probability of a candidate content item being clicked through a click probability predicting model according to an embodiment of the present disclosure.

FIG. 5 illustrates an exemplary process of a first-stage training for a click probability predicting model according to an embodiment of the present disclosure.

FIG. 6 is a flowchart of an exemplary method for content recommendation based on embedding summarization according to an embodiment of the present disclosure.

FIG. 7 illustrates an exemplary apparatus for content recommendation based on embedding summarization according to an embodiment of the present disclosure.

FIG. 8 illustrates an exemplary apparatus for content recommendation based on embedding summarization according to an embodiment of the present disclosure.

### DETAILED DESCRIPTION

The present disclosure will now be discussed with reference to several example implementations. It is to be understood that these implementations are discussed only for enabling those skilled in the art to better understand and thus implement the embodiments of the present disclosure, rather than suggesting any limitations on the scope of the present disclosure. A click probability of a target user clicking each of a set of candidate content items may be predicted through a transformer layer structure-based neural network model, thereby obtaining a set of click probabilities. Herein, a content item refers to an individual item with specific content. For example, a piece of news, a movie, a video, a product, etc., may be referred to as a content item. A content item to be recommended to the target user may be determined through ranking the set of click probabilities. The transformer layer structure-based neural network model may include, e.g., a Bidirectional Encoder Representations from Transformers (BERT) model, a Generative Pre-trained Transformer (GPT) model, and a Robustly optimized BERT approach (RoBERTa) model, the Decoding-enhanced BERT with Disentangled Attention (DeBERTa) model, etc. A text input for content recommendation may be provided to a transformer layer structure-based model. The text input includes a candidate content item. The transformer layer structure-based model may generate a text input representation of a text input through performing self-attention calculation based on self-attention mechanism. Furthermore, the transformer layer structure-based model may predict a click probability of the candidate content item being clicked based on the generated text input representation. Since the transformer layer structure-based model is usually a complex model that relies on a deep network with a huge amount of parameters, it may generate accurate text input representations and further obtain accurate click probability prediction results. But at the same time, online prediction using such a complex model is very time-consuming, which will lead to high prediction latency, especially when the input is a long text that includes a large amount of words.

Embodiment of the present disclosure propose content recommendation based on embedding summarization. Herein, embedding refers to an information set which is generated based on original data and is in a form that is conducive to being processed by a neural network model. A text input including a basic input and a context input corresponding to the basic input may be provided to a transformer layer structure-based neural network model according to the embodiments of the present disclosure. The basic input may include only a candidate content item or may include both a candidate content item and a query. The candidate content item may be a content item from a set of candidate content items that may be recommended to a target user. The query may be a search query from the target user. The context input may include historical interactions of the target user, historical search results for the query, etc. The neural network model may predict a click probability of a candidate content item being clicked based on the received text input. Herein, a neural network model used to predict a click probability is referred to as a click probability predicting model. An embedding sequence corresponding to a basic input and an embedding sequence corresponding to a context input may be generated through the click probability predicting model. A pooling operation may be performed on the embedding sequence corresponding to the basic input, to generate a pooling embedding corresponding to the basic input. The pooling embedding may be used to perform a summary operation on the embedding sequence corresponding to the context input, to obtain a representative embedding sequence corresponding to the context input. The number of embeddings in the representative embedding sequence corresponding to the context input can be significantly less than the number of embeddings in the embedding sequence corresponding to the context input. The embedding sequence corresponding to the basic input and the representative embedding sequence corresponding to the context input may be provided to a subsequent set of transformer layers, to be further processed to generate a text input representation of the text input. The generated text input representation may be used to predict a click probability of the candidate content item being clicked. In the click probability predicting model, the number of transformers included in each transformer layer corresponds to the number of embeddings provided to the transformer layer. In the case where the number of embeddings need to be processed is reduced, the number of transformers may also be reduced accordingly. Further, the calculation amount of self-attention calculations that need to be performed may be also reduced accordingly. Therefore, the latency in generating a text input representation and the latency in predicting a click probability may be reduced.

A summary operation may be performed on an embedding sequence corresponding to a context input with a pooling embedding, thereby reducing the number of embeddings provided to subsequent transformer layers. A pooling embedding may be generated through performing a pooling operation on an embedding sequence corresponding to a basic input including a candidate content item and/or a query. Accordingly, the pooling embedding may represent the meaning of the candidate content item and/or the query. Embeddings related to the candidate content item and/or the query may be selected from the embedding sequence corresponding to the context input through performing a summary operation with such pooling embedding. Since a target task of a click probability predicting model is to predict a click probability of a candidate content item being clicked, it is beneficial to select embeddings related to the candidate content item. For example, the context input may include historical interactions of a target user. The historical interactions may reflect user interests of the target user. Through performing the summary operation with the candidate content item, it can be determined whether the target user is interested in the candidate content item according to the historical interactions of the target user, and the user interest of the target user can be guided. The query may reflect the intent of the target user. Considering the query when selecting embeddings can help to select embeddings that are related to the intent of the target user. The approach described above may reduce the number of embeddings while retaining critical embeddings that are important for click probability prediction. This helps maintain the accuracy of prediction results. Before deploying a click probability predicting model for predicting a click probability online, the click probability predicting model may be trained. During the training of the click probability predicting model, as a training loss is minimized, parameters or weights of the model can be gradually optimized, so that critical embeddings that are important for click probability prediction can be gradually learned. A representative embedding sequence corresponding to a context input is selected from an original embedding sequence through similarity calculation with a candidate content item and/or a query. The selected representative embedding sequence corresponding to the context input dynamically changes during the training of the click probability predicting model, and can be gradually optimized. A self-attention operation may be performed on the selected representative embedding sequence through subsequent transformer layers, thereby further guaranteeing the learning effect. The model with the smallest training loss may be considered as the final model, and deployed to perform the click probability predicting task online.

A conventional transformer layer structure-based neural network model usually contains an embedding layer and a set of transformer layers. A click probability predicting model according to the embodiments of the present disclosure additionally contains a pooling layer and a summary layer. A pooling operation may be performed on an embedding sequence corresponding to a basic input through the pooling layer. A summary operation may be performed on an embedding sequence corresponding to a context input through the summary layer. Through the processing of the pooling layer and the summary layer, the number of embeddings provided to subsequent transformer layers may be reduced. The pooling layer and the summary layer may be located between the embedding layer and the bottommost transformer layer, or between two sets of transformer layers.

When the pooling layer and the summary layer are located between the embedding layer and the bottommost transformer layer, the number of embeddings provided to the bottommost transformer layer may be reduced. Thus, the number of transformers included in each of all transformer layers may be reduced. This can significantly reduce prediction latency. Under this model architecture, the pooling operation and the summary operation are performed based on an embedding sequence generated by the embedding layer. In order to ensure that the embedding layer is able to generate a high-quality embedding sequence so that a critical embedding that is important for click probability prediction may be selected when performing the summary operation, the embodiments of the present disclosure propose multi-stage training for the click probability predicting model, e.g., a first-stage training and a second-stage training. The first-stage training does not involve the pooling operation and the summary operation, and it aims to optimize the embedding layer so that the embedding layer has reasonable parameters or weights to generate high-quality embedding sequences. In the first-stage training, the number of transformers included in each transformer layer may be consistent with the number of original embeddings with no summary operations being performed. The second-stage training may be carried out on the basis of the first-stage training. The embedding layer in the click probability predicting model may be the embedding layer obtained through the first-stage training. In the second-stage training, the pooling operation and the summary operation may be performed.

Therefore, the number of embeddings provided to a set of transformer layers above the embedding layer may be reduced. In the second-stage training, the number of transformers included in each transformer layer may be consistent with the number of embeddings after a summary operation is performed. The click probability predicting model obtained through the second-stage training may be deployed to perform the click probability predicting task online.

When the pooling layer and the summary layer are located between two sets of transformer layers, e.g., on top of one or more transformer layers, the number of embeddings provided only to the upper set of transformer layers may be reduced. Therefore, only the number of transformers included in the upper set of transformer layers may be reduced. This can reduce prediction latency to some extent. The lower the pooling layer and the summary layer are in the model, the greater the reduction in prediction latency. Meanwhile, under this model architecture, the pooling operation and the summary operation are performed based on embedding sequences generated by a transformer layer. Such embedding sequences are generated through a self-attention mechanism and thus have high quality. Therefore, in this case, it is also possible to perform only one-stage training. For example, the second-stage training may be directly performed without performing the first-stage training described above. This can significantly save training costs.

The positions of the pooling layer and the summary layer in the click probability predicting model may be determined based on the requirement for prediction instantaneity and the requirement for training cost according to actual application requirements. If the requirement for prediction instantaneity is high, the pooling layer and the summary layer may be placed between the embedding layer and the bottommost transformer layer, while if the requirement for training cost is high, the pooling layer and the summary layer may be placed between two sets of transformer layers.

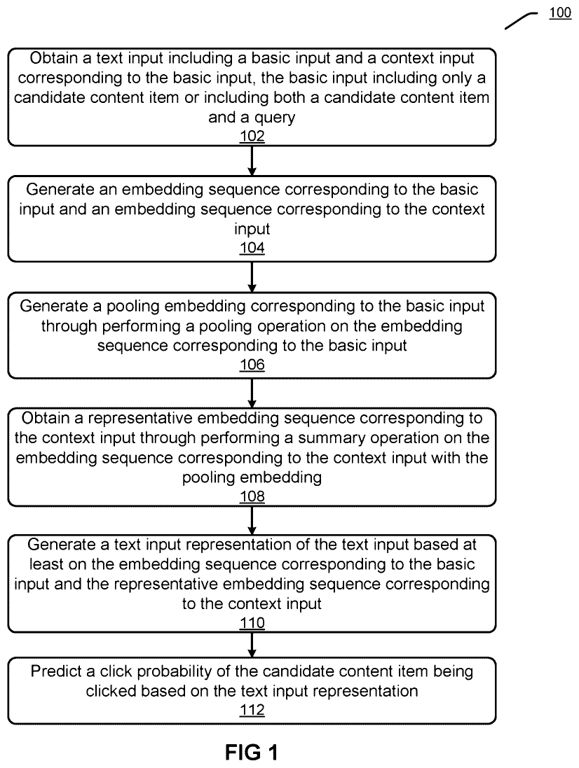

FIG. 1 illustrates an exemplary process 100 for content recommendation based on embedding summarization according to an embodiment of the present disclosure. A click probability of a candidate content item being clicked by a target user may be predicted through the process 100. The predicted click probability may be used to determine whether to recommend the candidate content item to the target user.

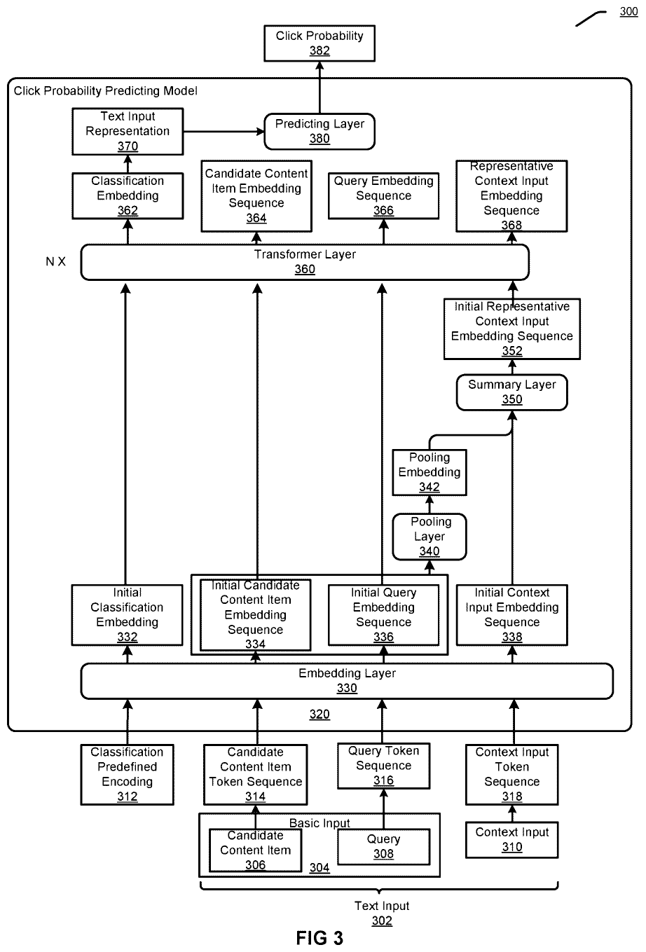

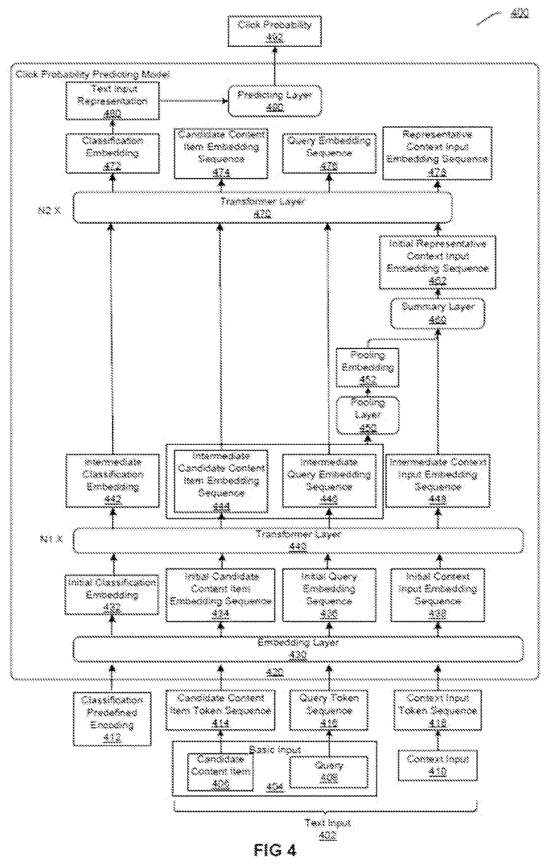

At 102, a text input may be obtained. The text input includes a basic input. The basic input may include only a candidate content item. The candidate content item may be a content item from a set of candidate content items that may be recommended to the target user. The candidate content item may include, e.g., news, video, movie, book, music, webpage, product information, etc. Alternatively, the basic input may include a query in addition to the candidate content item. That is, the basic input may include both a candidate content item and a query. The query may be a search query from the target user, e.g., a search query input by the target user in a search engine, in a news software, in a video application, etc. Additionally, the text input also includes a context input corresponding to the basic input. The context input may include historical interactions of the target user, e.g., long-term historical interactions and real-time historical interactions. The long-term historical interactions may include, e.g., queries that have been input, titles of content items that have been clicked, etc., by the target user in a long period of time in the past, e.g., in the past 3 months. The real-time historical interactions may include, e.g., queries that have been input, titles of content items that have been clicked, etc., by the target user in a short period of time in the past, e.g., in the past 4 hours. Historical interactions of a user are collected and used with notification to the user and permission from the user. In the case where the basic input includes a query, the context input may also include historical search results for the query. The historical search results may be used to interpret and expand the query. At 104, an embedding sequence corresponding to the basic input and an embedding sequence corresponding to the context input may be generated. A basic input token sequence corresponding to the basic input and a context input token sequence corresponding to the context input may be obtained through a tokenization operation. Herein, a token refers to a basic language unit that constitutes a text in different languages. An embedding sequence corresponding to a basic input may include an embedding corresponding to each token in the basic input token sequence. An embedding sequence corresponding to a context input may include an embedding corresponding to each token in the context input token sequence. An exemplary process of generating the embedding sequence corresponding to the basic input and the embedding sequence corresponding to the context input will be described later in conjunction with FIGS. 3 and 4.

At 106, a pooling embedding corresponding to the basic input may be generated through performing a pooling operation on the embedding sequence corresponding to the basic input.

The pooling operation may be any known pooling operation, e.g., a mean pooling operation, a max pooling operation, an attention pooling operation, etc.

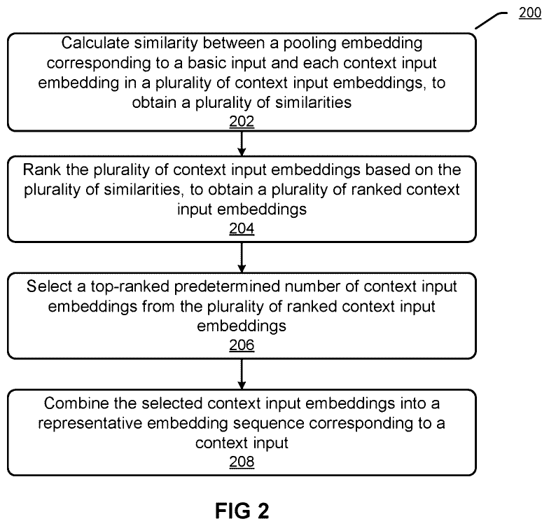

At 108, a representative embedding sequence corresponding to the context input may be obtained through performing a summary operation on the embedding sequence corresponding to the context input with the pooling embedding generated at 106. The number of embeddings in the representative embedding sequence corresponding to the context input can be significantly less than the number of embeddings in the embedding sequence corresponding to the context input. Preferably, the representative embedding sequence corresponding to the context input may include embeddings related to the basic input that are selected from the embedding sequence corresponding to the context input. FIG. 2 illustrates an exemplary process 200 for performing a summary operation on an embedding sequence corresponding to a context input according to an embodiment of the present disclosure.

The embedding sequence corresponding to the context input includes a plurality of context input embeddings. At 202, similarity between a pooling embedding corresponding to a basic input and each context input embedding in the plurality of context input embeddings may be calculated, to obtain a plurality of similarities. The similarity between the pooling embedding and the context input embedding may be calculated in a number of ways.

In an implementation, similarity between the pooling embedding and the context input embedding may be calculated through calculating an attention score between the pooling embedding and the context input embedding. The pooling embedding corresponding to the basic input may be denoted as E_{pooling}. The m th embedding in the embedding sequence corresponding to the context input may be denoted as Eₘ, where 1≤m≤M, M is the number of embeddings included in the embedding sequence corresponding to the context input. The process of calculating the attention score may be as shown by the following equation:

$$Similarity ( {E}_{Pooling} , {E}_{m} ) = Attention ( {E}_{Pooling} , {E}_{m} ) = softmax ( \frac{{E}_{Pooling} \cdot {E}_{m}^{T}}{\sqrt{d}} ) \qquad ( 1 )$$

where d is the coefficients used to perform a normalization operation.

In another implementation, similarity between the pooling embedding and the context input embedding may be calculated through calculating a cosine distance between the pooling embedding and the context input embedding. The process of calculating the cosine distance may be as follows:

$$Similarity ( {E}_{Pooling} , {E}_{m} ) = CosineDistance ( {E}_{Pooling} , {E}_{m} ) = \frac{{E}_{Pooling} \cdot {E}_{m}}{‖ {E}_{Pooling} ‖ \cdot ‖ {E}_{m} ‖} \qquad ( 2 )$$

It should be appreciated that the calculation of attention score or cosine distance between the pooling embedding and the context input embedding described above is only examples for calculating the similarity between the pooling embedding and the context input embedding, and the similarity between the pooling embedding and the context input embedding may also be calculated in other ways.

At 204, the plurality of context input embeddings may be ranked based on the obtained plurality of similarities, to obtain a plurality of ranked context input embeddings. For example, the plurality of context input embeddings may be ranked in descending order of similarity.

At 206, a top-ranked predetermined number of context input embeddings may be selected from the plurality of ranked context input embeddings.

At 208, the selected context input embeddings may be combined into a representative embedding sequence corresponding to the context input.

Referring back to FIG. 1, after the representative embedding sequence corresponding to the context input is obtained, at 110, a text input representation of the text input may be generated based at least on the embedding sequence corresponding to the basic input and the representative embedding sequence corresponding to the context input. Exemplary processes for generating the text input representation will be illustrated later in conjunction with FIGS. 3 and 4.

At 112, a click probability of the candidate content item being clicked may be predicted based on the text input representation. For example, in the case where the context input includes historical interactions of a target user, a click probability of the candidate content item being clicked by the target user may be predicted.

The process 100 may be performed for each content item in a set of candidate content items that may be recommended to a target user, thereby obtaining a set of click probabilities. Content item to be recommended to the target user may be determined based on the obtained set of click probabilities.

It should be appreciated that the process for content recommendation based on embedding summarization described above in conjunction with FIGS. 1 to 2 is merely exemplary. Depending on actual application requirements, the steps in the process for content recommendation based on embedding summarization may be replaced or modified in any manner, and the process may include more or fewer steps. Additionally, the specific order or hierarchy of the steps in the process 100 is merely exemplary, and the process for content recommendation based on embedding summarization may be performed in an order different from the described one.

The process 100 may be performed through a click probability predicting model according to an embodiment of the present disclosure, thereby predicting a click probability of a candidate content item being clicked. FIG. 3 illustrates an exemplary process 300 for predicting a click probability of a candidate content item being clicked through a click probability predicting model according to an embodiment of the present disclosure. In the process 300, the click probability predicting model 320 contains an embedding layer 330, a pooling layer 340, a summary layer 350, a set of transformer layers 360, a predicting layer 380, etc.

First, a text input 302 may be obtained. The text input 302 includes a basic input 304. The basic input 304 may include only a candidate content item 306 or may include both a candidate content item 306 and a query 308. The candidate content item 306 may be a content item from a set of candidate content items that may be recommended to a target user. The candidate content item may include, e.g., news, video, movie, book, music, webpage, product information, etc. The query 308 may be a search query from the target user, e.g., a search query input by the target user in a search engine, in a news software, in a video application, etc. Additionally, the text input 302 also includes a context input 310 corresponding to the basic input 304. The context input 310 may include historical interactions of the target user, e.g., long-term historical interactions and real-time historical interactions. Historical interactions of a user are collected and used with notification to the user and permission from the user. In the case where the basic input 304 includes the query 308, the context input 310 may also include historical search results for the query 308. The historical search results may be used to interpret and expand the query 308. The text length of the context input 310 typically far exceeds the text length of the basic input 304.

Subsequently, an embedding sequence corresponding to the basic input 304 and an embedding sequence corresponding to the context input 310 may be generated. A basic input token sequence corresponding to the basic input 304 and a context input token sequence corresponding to the context input 310 may be obtained. Further, an embedding sequence corresponding to the basic input 304 and an embedding sequence corresponding to the context input 310 may be generated based on at least one of a token embedding sequence, a segment embedding sequence, and a position embedding sequence corresponding to the basic input token sequence and the context input token sequence.

For example, a candidate content item token sequence 314 corresponding to the candidate content item 306, a query token sequence 316 corresponding to the query 308, and a context input token sequence 318 corresponding to the context input 310 may be obtained through a tokenization operation. Additionally, a predefined encoding, e.g., a classification predefined encoding 312 “[CLS]”, may be added before the token sequence. A predefined encoding, e.g., a separator predefined encoding “[September]”, may also be inserted into the token sequence to separate between tokens corresponding to different text segments.

The classification predefined encoding 312, the candidate content item token sequence 314, the query token sequence 316, and the context input token sequence 318 may be provided to the embedding layer 330 in the click probability predicting model 320. The structure and function of the embedding layer 330 may be similar to the structure and function of an embedding layer in a known transformer layer structure-based model, such as the BERT model. Compared to the classification predefined encoding 312, the candidate content item token sequence 314 and the query token sequence 316, the context input token sequence 318 typically contains a much larger number of tokens. That is, most of the input to the embedding layer 330 comes from the context input token sequence 318.

An embedding corresponding to the classification predefined encoding 312 may be generated through the embedding layer 330. For example, an initial classification embedding 332 corresponding to the classification predefined encoding 312 may be generated, through the embedding layer 330, based on at least one of a token embedding, a segment embedding, and a position embedding corresponding to the classification predefined encoding 312. Similarly, an initial candidate content item embedding sequence 334 corresponding to the candidate content item 306 may be generated, through the embedding layer 330, based on at least one of a token embedding sequence, a segment embedding sequence, and a position embedding sequence corresponding to the candidate content item token sequence 314. An initial query embedding sequence 336 corresponding to the query 308 may be generated, through the embedding layer 330, based on at least one of a token embedding sequence, a segment embedding sequence, and a position embedding sequence corresponding to the query token sequence 316. An initial context input embedding sequence 338 corresponding to the context input 310 may be generated, through the embedding layer 330, based on at least one of a token embedding sequence, a segment embedding sequence, and a position embedding sequence corresponding to the context input token sequence 318.

An embedding sequence corresponding to the basic input 304, e.g., the initial candidate content item embedding sequence 334 and the initial query embedding sequence 336 may be provided to the pooling layer 340. A pooling operation may be performed on the initial candidate content item embedding sequence 334 and the initial query embedding sequence 336 through a pooling layer 340, to generate a pooling embedding 342 corresponding to the basic input 304. The pooling operation may be any known pooling operation, e.g., a mean pooling operation, a max pooling operation, an attention pooling operation, etc.

Next, a summary operation may be performed on the initial context input embedding sequence 338 with the pooling embedding 342 through the summary layer 350, to obtain an initial representative context input embedding sequence 352 corresponding to the context input 310. The number of embeddings in the initial representative context input embedding sequence 352 can be significantly less than the number of embeddings in the initial context input embedding sequence 338. Preferably, the initial representative context input embedding sequence 352 may include embeddings associated with the basic input 304 selected from the initial context input embedding sequence 338. The summary operation may be performed on the initial context input embedding sequence 338 through the process 200 described in connection with FIG. 2. For example, similarity between the pooling embedding 342 and each of a plurality of context input embeddings included in the initial context input embedding sequence 338 may be first calculated, to obtain a plurality of similarities. Subsequently, the plurality of context input embeddings may be ranked based on the obtained plurality of similarities. Next, a top-ranked predetermined number of context input embeddings may be selected from the plurality of ranked context input embeddings. Then, the selected context input embeddings may be combined into the initial representative context input embedding sequence 352. Preferably, in order to enable the embeddings corresponding to different text segments to be separated from each other, the embedding corresponding to the separator predefined encoding “[September]” may be reserved.

After the initial representative context input embedding sequence 352 is obtained, a classification embedding, a basic input embedding sequence, and a representative context input embedding sequence may be generated based on the embedding corresponding to the classification predefined encoding 312, the embedding sequence corresponding to the basic input 304, and the representative embedding sequence corresponding to the context input 310 through a self-attention mechanism. For example, the classification embedding 362, the candidate content item embedding sequence 364, the query embedding sequence 366 and the representative context input embedding sequence 368 may be generated based on the initial classification embedding 332, the initial candidate content item embedding sequence 334, the initial query embedding sequence 336 and the initial representative context input embedding sequence 352 through a self-attention mechanism at a set of transformer layers 306. The set of transformer layers 360 includes, e.g., N (N≥1) transformer layers. The structure and function of each transformer layer may be similar to the structure and function of the transformer layer in a known transformer layer structure-based model, such as the BERT model. Subsequently, the classification embedding 362 may be used as the text input representation 370 of the text input 302.

Finally, a click probability 382 of the candidate content item 306 being clicked may be predicted based on the text input representation 370 through the predicting layer 380.

In the process 300, after the initial candidate content item embedding sequence 334, the initial query embedding sequence 336, and the initial context input embedding sequence 338 are generated through the embedding layer 330 in the click probability predicting model 320, a pooling embedding 342 may be generated by performing the pooling operation on the initial candidate content item embedding sequence 334 and the initial query embedding sequence 336 through the pooling layer 340. Next, the summary operation may be performed on the initial context input embedding sequence 338 with the pooling embedding 342 through the summary layer 350, to obtain the initial representative context input embedding sequence 352. The number of embeddings in the initial representative context input embedding sequence 352 can be significantly less than the number of embeddings in the initial context input embedding sequence 338. Therefore, the number of embeddings provided to the set of transformer layers 360 above the embedding layer 330 may be reduced through performing the pooling operation and the summary operation on top of the embedding layer 330. The number of transformers included in each transformer layer corresponds to the number of embeddings provided to the transformer layer. In the case where the number of embeddings need to be processed is reduced, the number of transformers may also be reduced accordingly. Further, the calculation amount of self-attention calculations that need to be performed may be also reduced accordingly. Therefore, the latency in generating the text input representation and the latency in predicting the click probability may be reduced.

In the process 300, the pooling operation and the summary operation are performed between the embedding layer and the bottommost transformer layer. The embodiments of the present disclosure also propose that the pooling operation and the summary operation may be performed between two sets of transformer layers. FIG. 4 illustrates another exemplary process 400 for predicting a click probability of the candidate content item being clicked through a click probability predicting model according to an embodiment of the present disclosure. In the process 400, a click probability predicting model 420 contains an embedding layer 430, a lower set of transformer layers 440, a pooling layer 450, a summary layer 460, an upper set of transformer layers 470, a predicting layer 490, etc. The lower set of transformer layers 440 includes, e.g., N1 transformer layers; the upper set of transformer layers 470 includes, e.g., N2 transformer layers, where N1≥1, and N1+N2=N.

First, a text input 402 may be obtained. The text input 402 includes a basic input 404. The basic input 404 may include only a candidate content item 406 or may include both a candidate content item 406 and a query 408. Additionally, the text input 402 also includes a context input 410 corresponding to the basic input 404. The text input 402, the basic input 404, the candidate content item 406, the query 408, and the context input 410 may correspond to the text input 302, the basic input 304, the candidate content item 306, the query 308, and the context input 310 in FIG. 3, respectively. The text length of the context input 410 typically far exceeds the text length of the basic input 404.

Subsequently, an embedding sequence corresponding to the basic input 404 and an embedding sequence corresponding to the context input 410 may be generated. A basic input token sequence corresponding to the basic input 404 and a context input token sequence corresponding to the context input 410 may be obtained. Further, an initial basic input embedding sequence and an initial context input embedding sequence may be generated based on at least one of a token embedding sequence, a segment embedding sequence, and a position embedding sequence corresponding to the basic input token sequence and the context input token sequence.

For example, a candidate content item token sequence 414 corresponding to the candidate content item 406, a query token sequence 416 corresponding to the query 408, and a context input token sequence 418 corresponding to the context input 410 may be obtained through a tokenization operation. Additionally, a predefined encoding, e.g., a classification predefined encoding 412 “[CLS]”, may be added before the token sequence. A predefined encoding, e.g., a separator predefined encoding “[September]”, may also be inserted into the token sequence to separate between tokens corresponding to different text segments.

The classification predefined encoding 412, the candidate content item token sequence 414, the query token sequence 416, and the context input token sequence 418 may be provided to the embedding layer 430 in the click probability predicting model 420. The structure and function of the embedding layer 430 may be similar to the structure and function of the embedding layer in a known transformer layer structure-based model, such as the BERT model. Compared to the classification predefined encoding 412, the candidate content item token sequence 414 and the query token sequence 416, the context input token sequence 418 typically contains a much larger number of tokens. That is, most of the input to the embedding layer 430 comes from the context input token sequence 418.

An embedding corresponding to the classification predefined encoding 412 may be generated through the embedding layer 430. For example, an initial classification embedding 432 corresponding to the classification predefined encoding 412 may be generated, through the embedding layer 430, based on at least one of a token embedding, a segment embedding, and a position embedding corresponding to the classification predefined encoding 412. Similarly, an initial candidate content item embedding sequence 434 corresponding to the candidate content item 406 may be generated, through the embedding layer 430, based on at least one of a token embedding sequence, a segment embedding sequence, and a position embedding sequence corresponding to the candidate content item token sequence 414. An initial query embedding sequence 436 corresponding to the query 408 may be generated, through the embedding layer 430, based on at least one of a token embedding sequence, a segment embedding sequence, and a position embedding sequence corresponding to the query token sequence 416. An initial context input embedding sequence 438 corresponding to the context input 410 may be generated, through the embedding layer 430, based on at least one of a token embedding sequence, a segment embedding sequence, and a position embedding sequence corresponding to the context input token sequence 418.

Subsequently, an embedding sequence corresponding to the basic input 404 and an embedding sequence corresponding to the context input 410 may be generated based on the initial basic input embedding sequence and the initial context input embedding sequence through a self-attention mechanism. For example, the initial classification embedding 432, the initial candidate content item embedding sequence 434, the initial query embedding sequence 436, and the initial context input embedding sequence 438 may be provided to the lower set of transformer layers 440. The structure and function of each transformer layer may be similar to the structure and function of the transformer layer in a known transformer layer structure-based model, such as the BERT model. An intermediate classification embedding 442, an intermediate candidate content item embedding sequence 444, an intermediate query embedding sequence 446 and an intermediate context input embedding sequence 448 may be generated based on the initial classification embedding 432, the initial candidate content item embedding sequence 434, the initial query embedding sequence 436 and the initial context input embedding sequence 438 through a self-attention mechanism at the transformer layer 440.

An embedding sequence corresponding to basic input 404, e.g., the intermediate candidate content item embedding sequence 444 and the intermediate query embedding sequence 446, may be provided to the pooling layer 450. A pooling embedding 452 corresponding to the basic input 404 may be generated through performing a pooling operation on the intermediate candidate content item embedding sequence 444 and the intermediate query embedding sequence 446 through the pooling layer 450. The pooling operation may be any known pooling operation, e.g., a mean pooling operation, a max pooling operation, an attention pooling operation, etc.

Next, a summary operation may be performed on the intermediate context input embedding sequence 448 with the pooling embedding 452 through the summary layer 460, to obtain an initial representative context input embedding sequence 462 corresponding to the context input 410. The number of embeddings in the initial representative context input embedding sequence 462 can be significantly less than the number of embeddings in the intermediate context input embedding sequence 448. Preferably, the initial representative context input embedding sequence 462 may include embeddings associated with the basic input 404 selected from the intermediate context input embedding sequence 448. The summary operation may be performed on the intermediate context input embedding sequence 448 through the process 200 described in connection with FIG. 2. For example, similarity between the pooling embedding 452 and each of a plurality of context input embeddings included in the intermediate context input embedding sequence 448 may be first calculated, to obtain a plurality of similarities. Subsequently, the plurality of context input embeddings may be ranked based on the obtained plurality of similarities. Next, a top-ranked predetermined number of context input embeddings may be selected from the plurality of ranked context input embeddings. Then, the selected context input embeddings may be combined into the initial representative context input embedding sequence 462. Preferably, in order to enable the embeddings corresponding to different text segments to be separated from each other, the embedding corresponding to the separator predefined encoding “[September]” may be reserved.

After the initial representative context input embedding sequence 462 is obtained, a classification embedding, a basic input embedding sequence, and a representative context input embedding sequence may be generated based on the embedding corresponding to the classification predefined encoding 412, the embedding sequence corresponding to the basic input 404, and the representative embedding sequence corresponding to the context input 410 through a self-attention mechanism. For example, a classification embedding 472, a candidate content item embedding sequence 474, a query embedding sequence 476 and a representative context input embedding sequence 478 may be generated based on the intermediate classification embedding 442, the intermediate candidate content item embedding sequence 444, the intermediate query embedding sequence 446 and the intermediate context input embedding sequence 448 through a self-attention mechanism at the upper set of transformer layers 470. Subsequently, the classification embedding 472 may be used as a text input representation 480 of the text input 402.

Finally, a click probability 492 of the candidate content item 406 being clicked may be predicted based on the text input representation 480 through the predicting layer 490.

In the process 400, after the intermediate candidate content item embedding sequence 444, the intermediate query embedding sequence 446, and the intermediate context input embedding sequence 448 are generated through the lower set of transformer layers 440 in the click probability predicting model 420, the pooling embedding 452 may be generated by performing the pooling operation on the intermediate candidate content item embedding sequence 444 and the intermediate query embedding sequence 446 through the pooling layer 450. Next, the summary operation may be performed on the intermediate context input embedding sequence 448 with the pooling embedding 452 through the summary layer 460, to obtain an initial representative context input embedding sequence 462. The number of embeddings in the initial representative context input embedding sequence 462 can be significantly less than the number of embeddings in the intermediate context input embedding sequence 448. Therefore, the number of embeddings provided to the upper set of transformer layers 470 may be reduced through performing the pooling operation and the summary operation on top of the lower set of transformer layers 440. The number of transformers included in each transformer layer corresponds to the number of embeddings provided to the transformer layer. In the case where the number of embeddings need to be processed is reduced, the number of transformers may also be reduced accordingly. Further, the calculation amount of self-attention calculations that need to be performed may be also reduced accordingly. Therefore, the latency in generating the text input representation 480 and the latency in predicting the click probability 492 may be reduced.

In the process 300 and the process 400, the summary operation may be performed on the embedding sequence corresponding to the context input with a pooling embedding, thereby reducing the number of embeddings provided to subsequent transformer layers. The pooling embedding may be generated through performing the pooling operation on the embedding sequence corresponding to the basic input including the candidate content item and/or the query. Accordingly, the pooling embedding may represent the meaning of the candidate content item and/or the query. Embeddings related to the candidate content item and/or the query may be selected from the embedding sequence corresponding to the context input through performing the summary operation with such a pooling embedding. Since the target task of the click probability predicting model is to predict a click probability of a candidate content item being clicked, it is beneficial to select embeddings related to the candidate content item. For example, the context input may include historical interactions of a target user. The historical interactions may reflect user interests of the target user. Through performing the summary operation with the candidate content item, it can be determined whether the target user is interested in the candidate content item according to the historical interactions of the target user, and the user interest of the target user can be guided. The query may reflect the intent of the target user. Considering the query when selecting embeddings can help to select embeddings that are related to the intent of the target user. The approach described above may reduce the number of embeddings while retaining critical embeddings that are important for click probability prediction. This helps maintain the accuracy of prediction results.

It should be appreciated that the processes for predicting the click probability of the candidate content item being clicked through the click probability predicting model described above in conjunction with FIGS. 3 and 4 is merely exemplary. Depending on actual application requirements, the steps in the process for predicting the click probability may be replaced or modified in any manner, and the process may include more or fewer steps. For example, although in the process 300 and the process 400, the basic input includes both the candidate content item and the query, in some embodiments, the basic input may include only the candidate content item. In this case, only the embedding sequence corresponding to the candidate content item may be generated. Accordingly, a pooling embedding may be obtained through only performing a pooling operation on the embedding sequence corresponding to the candidate content item. Additionally, the specific order or hierarchy of the steps in the process 300 and process 400 is merely exemplary, and the process for predicting the click probability may be performed in an order different from the described one. Furthermore, the click probability predicting models 320 and 420 shown in FIGS. 3 and 4 are merely examples of the click probability predicting model. Depending on the actual application requirements, the click probability predicting model may have any other structure and may include more or fewer layers.

Before deploying the click probability predicting model for predicting click probability online, the click probability predicting model may be trained. During the training of the click probability predicting model, as a training loss is minimized, parameters or weights of the model can be gradually optimized, so that critical embeddings that are important for click probability prediction can be gradually learned. A representative embedding sequence corresponding to a context input is selected from an original embedding sequence through similarity calculation with a candidate content item and/or a query. The selected representative embedding sequence corresponding to the context input dynamically changes during the training of the click probability predicting model, and can be gradually optimized. A self-attention operation may be performed on the selected representative embedding sequence through subsequent transformer layers, thereby further guaranteeing the learning effect. The model with the smallest training loss may be considered as a final model and deployed to perform the click probability predicting task online.

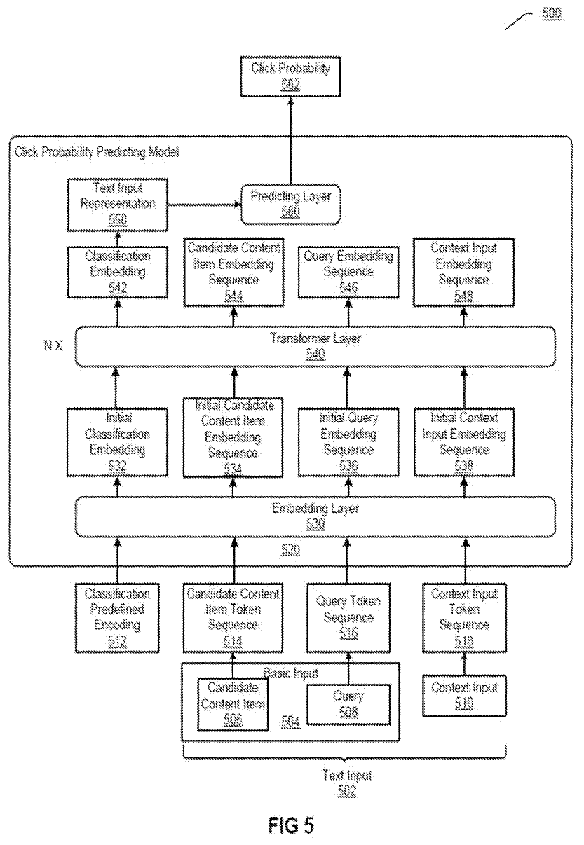

The click probability predicting model may be trained through multi-stage training. For example, training of the click probability predicting model may include a first-stage training and a second-stage training. FIG. 5 illustrates an exemplary process 500 of a first-stage training for a click probability predicting model according to an embodiment of the present disclosure. In the first-stage training, the architecture of the click probability predicting model may be different from the architecture of the click probability predicting model deployed online. As an example, the click probability predicting models 320 and 420 may be click probability predicting models deployed online. In the process 500, a click probability predicting model 520 contains an embedding layer 530, a set of transformer layers 540, a predicting layer 560, etc. In contrast to the click probability predicting models 320 and 420, the click probability predicting model 520 does not contain a pooling layer and a summary layer.

First, a text input 502 may be obtained. The text input 502 includes a basic input 504. The basic input 504 may include only a candidate content item 506 or may include both a candidate content item 506 and a query 508. Additionally, the text input 502 also includes a context input 510 corresponding to the basic input 504. The text input 502, the basic input 504, the candidate content item 506, the query 508, and the context input 510 may correspond to the text input 302, the basic input 304, the candidate content item 306, the query 308, and the context input 310 in FIG. 3, respectively. The text length of the context input 510 typically far exceeds the text length of the basic input 504.

A candidate content item token sequence 514 corresponding to the candidate content item 506, a query token sequence 516 corresponding to the query 508, and a context input token sequence 518 corresponding to the context input 510 may be obtained through a tokenization operation.

Additionally, a predefined encoding, e.g., a classification predefined encoding 512 “[CLS]”, may be added before the token sequence. A predefined encoding, e.g., a separator predefined encoding “[September]”, may also be inserted into the token sequence to separate between tokens corresponding to different text segments.

The classification predefined encoding 512, the candidate content item token sequence 514, the query token sequence 516, and the context input token sequence 518 may be provided to an embedding layer 530 in the click probability predicting model 520. The structure and function of the embedding layer 530 may be similar to the structure and function of the embedding layer in a known transformer layer structure-based model, such as the BERT model. An initial classification embedding 532 corresponding to the classification predefined encoding 512 may be generated, through the embedding layer 330, based on at least one of a token embedding, a segment embedding, and a position embedding corresponding to the classification predefined encoding 512. Similarly, an initial candidate content item embedding sequence 534 corresponding to the candidate content item 506 may be generated, through the embedding layer 530, based on at least one of a token embedding sequence, a segment embedding sequence, and a position embedding sequence corresponding to the candidate content item token sequence 514. An initial query embedding sequence 536 corresponding to the query 508 may be generated, through the embedding layer 530, based on at least one of a token embedding sequence, a segment embedding sequence, and a position embedding sequence corresponding to the query token sequence 516. An initial context input embedding sequence 538 corresponding to the context input 510 may be generated, through the embedding layer 530, based on at least one of a token embedding sequence, a segment embedding sequence, and a position embedding sequence corresponding to the context input token sequence 518.

The first-stage training does not involve a pooling operation and a summary operation. Accordingly, a text input representation may be generated based at least on the embedding sequence corresponding to the basic input 504 and the embedding sequence corresponding to the context input 510. The initial classification embedding 532, the initial candidate content item embedding sequence 534, the initial query embedding sequence 536, and the initial context input embedding sequence 538 may be provided to a set of transformer layers 540. The set of transformer layers 540 includes, e.g., N transformer layers. The structure and function of each transformer layer may be similar to the structure and function of the transformer layer in a known transformer layer structure-based model, such as the BERT model. A classification embedding 542, a candidate content item embedding sequence 544, a query embedding sequence 546 and a representative context input embedding sequence 548 may be generated based on the initial classification embedding 532, the initial candidate content item embedding sequence 534, the initial query embedding sequence 536 and the initial context input embedding sequence 538 through a self-attention mechanism at the set of transformer layers 540. Subsequently, the classification embedding 542 may be used as a text input representation 550 of the text input 502.

Finally, a click probability 562 of the candidate content item 506 being clicked may be predicted based on the text input representation 550 through a predicting layer 560.

The first-stage training as shown in the process 500 does not involve the pooling operation and the summary operation, and it aims to optimize the embedding layer 530 so that the embedding layer 530 has reasonable parameters or weights to generate high-quality embedding sequences. In the first-stage training, the number of transformers included in the transformer layer may be consistent with the number of initial embeddings with no summary operation being performed. After the first-stage training is performed on the click probability predicting model, the second-stage training may be performed on the click probability predicting model. The second-stage training may be carried out on the basis of the first-stage training. In the second-stage training, the architecture of the click probability predicting model may be similar to the architecture of the click probability predicting model deployed online. The embedding layer in the click probability predicting model may be the embedding layer obtained through the first-stage training. In the second-stage training, the pooling operation and the summary operation may be performed. Since the embedding layer obtained through the first-stage training has reasonable parameters or weights, high-quality embedding sequences may be generated. Accordingly, through performing the pooling operation and the summary operation based on such an embedding sequence, a critical representative embedding sequence that is important for click probability prediction may be selected from the embedding sequence corresponding to the context input. Therefore, in the second-stage training, the number of embeddings provided to subsequent transformer layers may be reduced. The number of transformers included in each transformer layer corresponds to the number of embeddings provided to the transformer layer. In the case where the number of embeddings need to be processed is reduced, the number of transformers may also be reduced accordingly. The number of transformers included in a transformer layer may be consistent with the number of embeddings after the summary operation is performed.

Thus, the numbers of transformers included in a transformer layer in the click probability predicting model may be different in the first-stage training and in the second-stage training. Assuming that in the first-stage training, the transformer layer may include a first number of transformers, and in the second-stage training, the transformer layer may include a second number of transformers, the second number may be less than the first number. The click probability predicting model obtained through the second-stage training may be deployed to perform the click probability predicting task online.

In contrast to the conventional transformer layer structure-based neural network model, the click probability predicting model according to the embodiments of the present disclosure, e.g., the click probability predicting models 320 and 420 shown in FIGS. 3 and 4, additionally includes a pooling layer and a summary layer. A pooling operation may be performed on an embedding sequence corresponding to a basic input through the pooling layer. A summary operation may be performed on a embedding sequence corresponding to a context input through the summary layer. Through the processing of the pooling layer and the summary layer, the number of embeddings provided to subsequent transformer layers may be reduced. The pooling layer and the summary layer may be located between the embedding layer and the bottommost transformer layer, or between two sets of transformer layers. In the click probability predicting model 320, the pooling layer and the summary layer are located between the embedding layer and the bottommost transformer layer. The number of embeddings provided to the bottommost transformer layer may be reduced. Thus, the number of transformers included in each of all transformer layers may be reduced. This can significantly reduce prediction latency. In the click probability predicting model 420, the pooling layer and the summary layer are located between two sets of transformer layers, e.g., on top of one or more transformer layers. The number of embeddings provided only to the upper set of transformer layers may be reduced. Therefore, only the number of transformers included in the upper set of transformer layers may be reduced.

This can reduce prediction latency to some extent. The lower the pooling layer and the summary layer are in the model, the greater the reduction in prediction latency. Meanwhile, in the click probability predicting model 420, the pooling operation and the summary operation are performed based on the embedding sequences generated by the transformer layer. Such embedding sequences are generated through a self-attention mechanism and thus have high quality. Therefore, for the click probability predicting model 420, it is also possible to perform only one-stage training. For example, the second-stage training may be directly performed without performing the first-stage training described above. This can significantly save training costs. The positions of the pooling layer and the summary layer in the click probability predicting model may be determined based on the requirement for prediction instantaneity and the requirement for training cost according to actual application requirements. If the requirement for prediction instantaneity is high, the pooling layer and the summary layer may be placed between the embedding layer and the bottommost transformer layer, while if the requirement for training cost is high, the pooling layer and the summary layer may be placed between two sets of transformer layers.

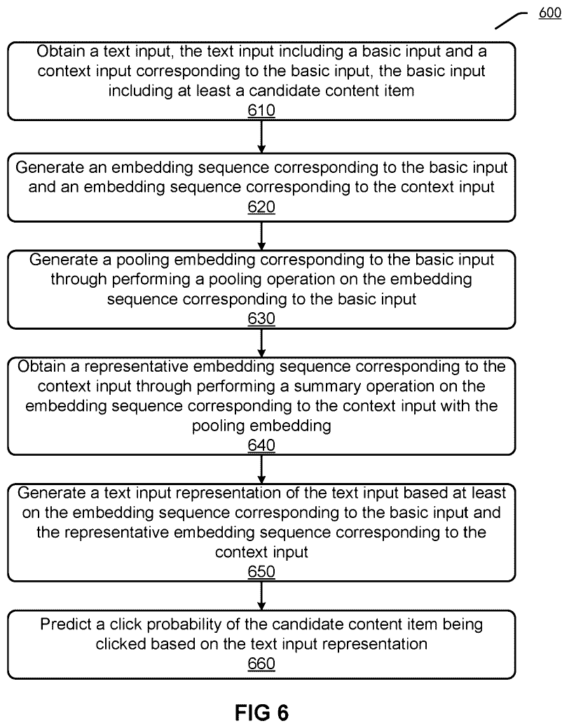

FIG. 6 is a flowchart of an exemplary method 600 for content recommendation based on embedding summarization according to an embodiment of the present disclosure.

At 610, a text input may be obtained, the text input including a basic input and a context input corresponding to the basic input, the basic input including at least a candidate content item. At 620, an embedding sequence corresponding to the basic input and an embedding sequence corresponding to the context input may be generated.

At 630, a pooling embedding corresponding to the basic input may be generated through performing a pooling operation on the embedding sequence corresponding to the basic input. At 640, a representative embedding sequence corresponding to the context input may be obtained through performing a summary operation on the embedding sequence corresponding to the context input with the pooling embedding.

At 650, a text input representation of the text input may be generated based at least on the embedding sequence corresponding to the basic input and the representative embedding sequence corresponding to the context input.

At 660, a click probability of the candidate content item being clicked may be predicted based on the text input representation.

In an implementation, the generating an embedding sequence corresponding to the basic input and an embedding sequence corresponding to the context input may comprise: obtaining a basic input token sequence corresponding to the basic input and a context input token sequence corresponding to the context input; and generating the embedding corresponding to the basic input and the embedding sequence corresponding to the context input based on at least one of a token embedding sequence, a segment embedding sequence, and a position embedding sequence corresponding to the basic input token sequence and the context input token sequence. In an implementation, the generating an embedding sequence corresponding to the basic input and an embedding sequence corresponding to the context input may comprise: obtaining a basic input token sequence corresponding to the basic input and a context input token sequence corresponding to the context input; generating an initial basic input embedding sequence and an initial context input embedding sequence based on at least one of a token embedding sequence, a segment embedding sequence, and a position embedding sequence corresponding to the basic input token sequence and the context input token sequence; and generating the embedding sequence corresponding to the basic input and the embedding sequence corresponding to the context input based on the initial basic input embedding sequence and the initial context input embedding sequence through a self-attention mechanism.

In an implementation, the number of embeddings in the representative embedding sequence corresponding to the context input may be less than the number of embeddings in the embedding sequence corresponding to the context input.

In an implementation, the representative embedding sequence corresponding to the context input may include embeddings related to the basic input that are selected from the embedding sequence corresponding to the context input.

In an implementation, the embedding sequence corresponding to the context input may include a plurality of context input embeddings. The performing a summary operation may comprise: calculating similarity between the pooling embedding and each context input embedding in the plurality of context input embeddings, to obtain a plurality of similarities; ranking the plurality of context input embeddings based on the plurality of similarities, to obtain a plurality of ranked context input embeddings; selecting a top-ranked predetermined number of context input embeddings from the plurality of ranked context input embeddings; and combining the selected context input embeddings into the representative embedding sequence corresponding to the context input.

In an implementation, the generating a text input representation may comprise: generating an embedding corresponding to a classification predefined encoding; generating a classification embedding, a basic input embedding sequence, and a representative context input embedding sequence based on the embedding corresponding to the classification predefined encoding, the embedding sequence corresponding to the basic input, and the representative embedding sequence corresponding to the context input through a self-attention mechanism; and taking the classification embedding as the text input representation.

In an implementation, the basic input may further include a query.

The context input may include historical search results for the query.

In an implementation, the context input may include historical interactions of a target user. The predicting a click probability may include: predicting a click probability of the candidate content item being clicked by the target user.

In an implementation, the click probability may be predicted through a click probability predicting model. The representative embedding sequence corresponding to the context input may be gradually optimized during training of the click probability predicting model. In an implementation, the click probability may be predicted through a click probability predicting model. Training of the click probability predicting model may include a first-stage training and a second-stage training. The numbers of transformers included in a transformer layer in the click probability predicting model may be different in the first-stage training and in the second-stage training.

A transformer layer in the click probability predicting model in the first-stage training may include a first number of transformers. A transformer layer in the click probability predicting model in the second-stage training may include a second number of transformers. The second number is less than the first number.

In the first-stage training, the text input representation may be generated based at least on the embedding sequence corresponding to the basic input and the embedding sequence corresponding to the context input.

In an implementation, the candidate content item may include at least one of news, video, movie, book, music, web page, and product information.

It should be appreciated that the method 600 may further comprise any step/process for content recommendation based on embedding summarization according to the embodiments of the present disclosure as mentioned above.

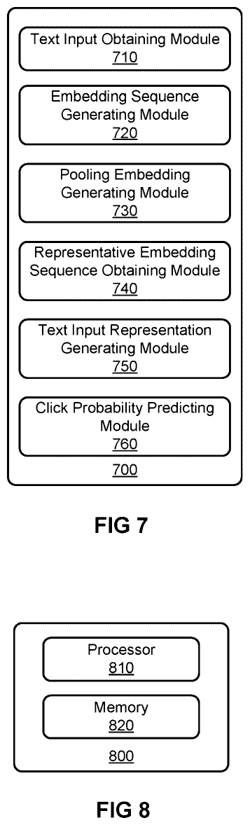

FIG. 7 illustrates an exemplary apparatus 700 for content recommendation based on embedding summarization according to an embodiment of the present disclosure.

The apparatus 700 may comprise: a text input obtaining module 710, for obtaining a text input, the text input including a basic input and a context input corresponding to the basic input, the basic input including at least a candidate content item; an embedding sequence generating module 720, for generating an embedding sequence corresponding to the basic input and an embedding sequence corresponding to the context input; a pooling embedding generating module 730, for generating a pooling embedding corresponding to the basic input through performing a pooling operation on the embedding sequence corresponding to the basic input; a representative embedding sequence obtaining module 740, for obtaining a representative embedding sequence corresponding to the context input through performing a summary operation on the embedding sequence corresponding to the context input with the pooling embedding; a text input representation generating module 750, for generating a text input representation of the text input based at least on the embedding sequence corresponding to the basic input and the representative embedding sequence corresponding to the context input; and a click probability predicting module 760, for predicting a click probability of the candidate content item being clicked based on the text input representation. Moreover, the apparatus 700 may further comprise any other modules configured for content recommendation based on embedding summarization according to the embodiments of the present disclosure as mentioned above.

FIG. 8 illustrates an exemplary apparatus 800 for content recommendation based on embedding summarization according to an embodiment of the present disclosure.

The apparatus 800 may comprise a processor 810; and a memory 820 storing computer-executable instructions. The computer-executable instructions, when executed, may cause the processor 810 to: obtain a text input, the text input including a basic input and a context input corresponding to the basic input, the basic input including at least a candidate content item, generate an embedding sequence corresponding to the basic input and an embedding sequence corresponding to the context input, generate a pooling embedding corresponding to the basic input through performing a pooling operation on the embedding sequence corresponding to the basic input, obtain a representative embedding sequence corresponding to the context input through performing a summary operation on the embedding sequence corresponding to the context input with the pooling embedding, generate a text input representation of the text input based at least on the embedding sequence corresponding to the basic input and the representative embedding sequence corresponding to the context input, and predict a click probability of the candidate content item being clicked based on the text input representation.

In an implementation, the representative embedding sequence corresponding to the context input may include embeddings related to the basic input that are selected from the embedding sequence corresponding to the context input.

In an implementation, the basic input may further include a query.

In an implementation, the click probability may be predicted through a click probability predicting model. Training of the click probability predicting model may include a first-stage training and a second-stage training. The numbers of transformers included in a transformer layer in the click probability predicting model may be different in the first-stage training and in the second-stage training.

It should be appreciated that the processor 810 may further perform any other steps/processes of the method for content recommendation based on embedding summarization according to the embodiments of the present disclosure as mentioned above.

The embodiment of the present disclosure propose a computer program product for content recommendation based on embedding summarization, comprising a computer program that is executed by a processor for: obtaining a text input, the text input including a basic input and a context input corresponding to the basic input, the basic input including at least a candidate content item; generating an embedding sequence corresponding to the basic input and an embedding sequence corresponding to the context input; generating a pooling embedding corresponding to the basic input through performing a pooling operation on the embedding sequence corresponding to the basic input; obtaining a representative embedding sequence corresponding to the context input through performing a summary operation on the embedding sequence corresponding to the context input with the pooling embedding; generating a text input representation of the text input based at least on the embedding sequence corresponding to the basic input and the representative embedding sequence corresponding to the context input; and predicting a click probability of the candidate content item being clicked based on the text input representation. Additionally, the computer program may further be performed for implementing any other steps/processes of the method for content recommendation based on embedding summarization according to the embodiments of the present disclosure as mentioned above. The embodiments of the present disclosure may be embodied in a non-transitory computer-readable medium. The non-transitory computer readable medium may comprise instructions that, when executed, cause one or more processors to perform any operation of the method for content recommendation based on embedding summarization according to the embodiments of the present disclosure as mentioned above.

It should be appreciated that all the operations in the methods described above are merely exemplary, and the present disclosure is not limited to any operations in the methods or sequence orders of these operations, and should cover all other equivalents under the same or similar concepts. In addition, the articles “a” and “an” as used in this specification and the appended claims should generally be construed to mean “one” or “one or more” unless specified otherwise or clear from the context to be directed to a singular form.

It should also be appreciated that all the modules in the apparatuses described above may be implemented in various approaches. These modules may be implemented as hardware, software, or a combination thereof. Moreover, any of these modules may be further functionally divided into sub-modules or combined together.

Processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in the present disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured for performing the various functions described throughout the present disclosure. The functionality of a processor, any portion of a processor, or any combination of processors presented in the present disclosure may be implemented with software being executed by a microprocessor, microcontroller, DSP, or other suitable platform. Software shall be construed broadly to mean instructions, instruction sets, code, code segments, program code, programs, subprograms, software modules, applications, software applications, software packages, routines, subroutines, objects, threads of execution, procedures, functions, etc. The software may reside on a computer-readable medium. A computer-readable medium may include, by way of example, memory such as a magnetic storage device (e.g., hard disk, floppy disk, magnetic strip), an optical disk, a smart card, a flash memory device, random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout the present disclosure, the memory may be internal to the processors, e.g., cache or register.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein. All structural and functional equivalents to the elements of the various aspects described throughout the present disclosure that are known or later come to be known to those of ordinary skilled in the art are expressly incorporated herein and intended to be encompassed by the claims.

1. A method for content recommendation based on embedding summarization, comprising:
obtaining a text input, the text input including a basic input and a context input corresponding to the basic input, the basic input including at least a candidate content item;
generating an embedding sequence corresponding to the basic input and an embedding sequence corresponding to the context input;
generating a pooling embedding corresponding to the basic input through performing a pooling operation on the embedding sequence corresponding to the basic input;
obtaining a representative embedding sequence corresponding to the context input through performing a summary operation on the embedding sequence corresponding to the context input with the pooling embedding;
generating a text input representation of the text input based at least on the embedding sequence corresponding to the basic input and the representative embedding sequence corresponding to the context input; and
predicting a click probability of the candidate content item being clicked based on the text input representation.

2. The method of claim 1, wherein the generating an embedding sequence corresponding to the basic input and an embedding sequence corresponding to the context input comprises:
obtaining a basic input token sequence corresponding to the basic input and a context input token sequence corresponding to the context input; and
generating the embedding corresponding to the basic input and the embedding sequence corresponding to the context input based on at least one of a token embedding sequence, a segment embedding sequence, and a position embedding sequence corresponding to the basic input token sequence and the context input token sequence.

3. The method of claim 1, wherein the generating an embedding sequence corresponding to the basic input and an embedding sequence corresponding to the context input comprises:
obtaining a basic input token sequence corresponding to the basic input and a context input token sequence corresponding to the context input;
generating an initial basic input embedding sequence and an initial context input embedding sequence based on at least one of a token embedding sequence, a segment embedding sequence, and a position embedding sequence corresponding to the basic input token sequence and the context input token sequence; and
generating the embedding sequence corresponding to the basic input and the embedding sequence corresponding to the context input based on the initial basic input embedding sequence and the initial context input embedding sequence through a self-attention mechanism.

4. The method of claim 1, wherein the number of embeddings in the representative embedding sequence corresponding to the context input is less than the number of embeddings in the embedding sequence corresponding to the context input.

5. The method of claim 1, wherein the representative embedding sequence corresponding to the context input includes embeddings relevant to the basic input that are selected from the embedding sequence corresponding to the context input.

6. The method of claim 1, wherein the embedding sequence corresponding to the context input comprises a plurality of context input embeddings, and the performing a summary operation comprises:
calculating similarity between the pooling embedding and each context input embedding in the plurality of context input embeddings, to obtain a plurality of similarities;
ranking the plurality of context input embeddings based on the plurality of similarities, to obtain a plurality of ranked context input embeddings;
selecting a top-ranked predetermined number of context input embeddings from the plurality of ranked context input embeddings; and
combining the selected context input embeddings into the representative embedding sequence corresponding to the context input.

7. The method of claim 1, wherein the generating a text input representation comprises:
generating an embedding corresponding to a classification predefined encoding;
generating a classification embedding, a basic input embedding sequence, and a representative context input embedding sequence based on the embedding corresponding to the classification predefined encoding, the embedding sequence corresponding to the basic input, and the representative embedding sequence corresponding to the context input through a self-attention mechanism; and
taking the classification embedding as the text input representation.

8. The method of claim 1, wherein the basic input further includes a query.

9. The method of claim 8, wherein the context input includes historical search results for the query.

10. The method of claim 1, wherein the click probability is predicted through a click probability predicting model, and the representative embedding sequence corresponding to the context input is gradually optimized during training of the click probability predicting model.

11. The method of claim 1, wherein the click probability is predicted through a click probability predicting model, training of the click probability predicting model includes a first-stage training and a second-stage training, and the numbers of transformers included in a transformer layer in the click probability predicting model are different in the first-stage training and in the second-stage training.

12. The method of claim 11, wherein a transformer layer in the click probability predicting model in the first-stage training includes a first number of transformers, a transformer layer in the click probability predicting model in the second-stage training includes a second number of transformers, and the second number is less than the first number.

13. The method of claim 11, wherein in the first-stage training, the text input representation is generated based at least on the embedding sequence corresponding to the basic input and the embedding sequence corresponding to the context input embedding sequence.

14. An apparatus for content recommendation based on embedding summarization, comprising:
a processor; and
a memory storing computer-executable instructions that, when executed, cause the processor to:
obtain a text input, the text input including a basic input and a context input corresponding to the basic input, the basic input including at least a candidate content item, generate an embedding sequence corresponding to the basic input and an embedding sequence corresponding to the context input,
generate a pooling embedding corresponding to the basic input through performing a pooling operation on the embedding sequence corresponding to the basic input, obtain a representative embedding sequence corresponding to the context input through performing a summary operation on the embedding sequence corresponding to the context input with the pooling embedding,
generate a text input representation of the text input based at least on the embedding sequence corresponding to the basic input and the representative embedding sequence corresponding to the context input, and
predict a click probability of the candidate content item being clicked based on the text input representation.

15. A computer program product for content recommendation based on embedding summarization, comprising a computer program that is executed by a processor for:
obtaining a text input, the text input including a basic input and a context input corresponding to the basic input, the basic input including at least a candidate content item;
generating an embedding sequence corresponding to the basic input and an embedding sequence corresponding to the context input;
generating a pooling embedding corresponding to the basic input through performing a pooling operation on the embedding sequence corresponding to the basic input;
obtaining a representative embedding sequence corresponding to the context input through performing a summary operation on the embedding sequence corresponding to the context input with the pooling embedding;
generating a text input representation of the text input based at least on the embedding sequence corresponding to the basic input and the representative embedding sequence corresponding to the context input; and
predicting a click probability of the candidate content item being clicked based on the text input representation.
